(19) United States
(12) Patent Application Publication
(10) Pub. No.: US 2012/0073704 A1
(43) Pub. Date: Mar. 29, 2012

(54) LOG SPLITTER

(76) Inventor: Joshua Larrabee, Stacy, MN (US)

(21) Appl. No.: 12/888,792

(22) Filed: Sep. 23, 2010

(51) Int. Cl. B27L 7/06

(52) U.S. Cl. 144/195.1

(57) ABSTRACT

A portable hydraulic log splitter has a primary log splitting table mounted on a wheeled transportation vehicle with two lateral opposing secondary log splitting tables adjoining the primary splitting table. Opposing horizontal primary splitting blades are fixedly mounted on the secondary log splitting tables. Opposing vertical secondary splitting blades are fixedly mounted on the secondary log splitting tables and below and fixed to the primary splitting blades. The secondary splitting blades are laterally outwardly staggered from the primary splitting blades. A backstop is mounted on the primary splitting table to prevent the log from falling off the primary splitting table. A lateral reciprocating log push block is slideably mounted on the primary log splitting table through a slot therein and extending below whereat it is connected to a hydraulic cylinder to move the log push block laterally back and forth. Foldable laterally opposing chutes receive the split pieces to dispense the pieces outwardly into two opposing rows of split pieces away from the operator. A hydraulically activated L-shaped loading ramp adjacent the primary splitting table that lifts logs onto the primary splitting table opposite the backstop from the ground and when lowered operates as an operator stand when operating the log splitter.

### BACKGROUND OF THE INVENTION

The present invention relates to a powered hydraulic log splitter which simultaneously splits logs horizontally and vertically and can be reversibly run to split logs at both ends of the machine.

Log splitters are in common use. A channel box or rail typically supports the fixed splitting blade and a movable push plate on the end of a cylinder ram. However, these maybe reversed. The log is picked up by the operator and balanced on the channel box. The log is pushed between the ram plate and the wedge-shaped fixed splitting blade. The push plate engages one end of the log and moves the log into forceful engagement with the sharp edge of the splitting blade and continues the movement of the log relative to the blade to effect a splitting of the log.

In such log splitters the sharp edge of the blade penetrates the end of the log and as the log continues to move relative to the blade, the side surfaces of the wedge will force the log to split. During the splitting process the log is held in place by operator hands and the tension created by the force of the push plate against the log end. The split log then falls off the log splitter while the operator watches with care as to not be hit in the foot or leg by one of the falling log halves. The log halves are then picked up and split again perhaps several times. This is a slow process.

Applicant is not aware of any log splitter that requires no lifting and simultaneously splits a log horizontally into halves and the halves vertically into split pieces. Applicant is also unaware of any log splitter that alternates the direction of movement of the log push plate to alternately split the logs at either end of the log splitter and dispenses the split pieces out the sides of the log splitter away from the operator.

In existing log splitters, the log push plate is generally driven by a hydraulic piston, but the piston is exposed to splinters from the split logs, which may cause the piston to jam.

There is a need for a powered, hydraulic log splitter that addresses the above deficiencies.

### SUMMARY OF THE INVENTION

A portable hydraulic log splitter has a primary log splitting table mounted on a wheeled transportation vehicle with two lateral opposing secondary log splitting tables adjoining the primary splitting table. Opposing horizontal primary splitting blades are fixedly mounted on the secondary log splitting tables. Opposing vertical secondary splitting blades are fixedly mounted on the secondary log splitting tables and below and fixed to the primary splitting blades. The secondary splitting blades are laterally outwardly staggered from the primary splitting blades. A backstop is mounted on the primary splitting table to prevent the log from falling off the primary splitting table. A lateral reciprocating log push block is slideably mounted on the primary log splitting table through a slot therein and extending below whereat it is connected to a hydraulic cylinder to move the log push block laterally back and forth. Foldable laterally opposing chutes receive the split pieces to dispense the pieces outwardly into two opposing rows of split pieces away from the operator. A hydraulically activated L-shaped loading ramp adjacent the primary splitting table that lifts logs onto the primary splitting table opposite the backstop from the ground and when lowered operates as an operator stand when operating the log splitter.

A principle object and advantage of the present invention is that it splits logs simultaneously horizontally and vertically.

Another principle object and advantage of the present invention is that it alternates splitting of the same log at opposite ends of the splitter for fast smooth operation.

Another object and advantage of the present invention is that the hydraulic ram is enclosed within and below the splitting table and is therefore protected from being jammed by log splinters.

Another object and advantage of the present invention is that it is simply backed into a log pile and dispenses with the split pieces in two neat rows.

Another object and advantage of the invention is that it requires no lifting by the operator and the split log pieces are dispensed away from the operator.

### BRIEF DESCRIPTION OF DRAWINGS

FIG. 1 is a perspective view of a log splitter of the present invention in the folded, transportation position.

FIG. 2 is similar to FIG. 1, but with the log splitter being readied for operation, the ramp being lowered.

FIG. 3 is similar to FIG. 2, but with the log splitter shown in the fully operational position.

FIGS. 4-7 are broken away views of the log splitter at approximately lines 4-4 of FIG. 3, showing the use of the ramp.

FIGS. 8-11 are cross-sectional views of the log splitter at approximately lines 8-8 of FIG. 3, showing the operation of the splitting mechanism.

FIGS. 12 and 13 are broken away top plan views of the splitting blades, showing a log being split horizontally and vertically.

FIG. 14 is a perspective view of the hydraulic piston and reciprocating channel box within the fixed channel box below the splitting table with some structure cut away to show internal details.

FIGS. 15-17 are top plan views of the operation of the invention.

### DETAILED DESCRIPTION OF THE PREFERRED EMBODIMENT

The log splitter of the present invention is generally shown in the Figures as reference numeral 10. The splitter 10 generally includes a primary log splitter table 30, two laterally opposing secondary log splitting tables 52, opposing primary and secondary log splitting blades 94 and 96 on the secondary log splitting tables 52, and a laterally reciprocating log push block 90 slideably mounted on the primary log splitting table 30.

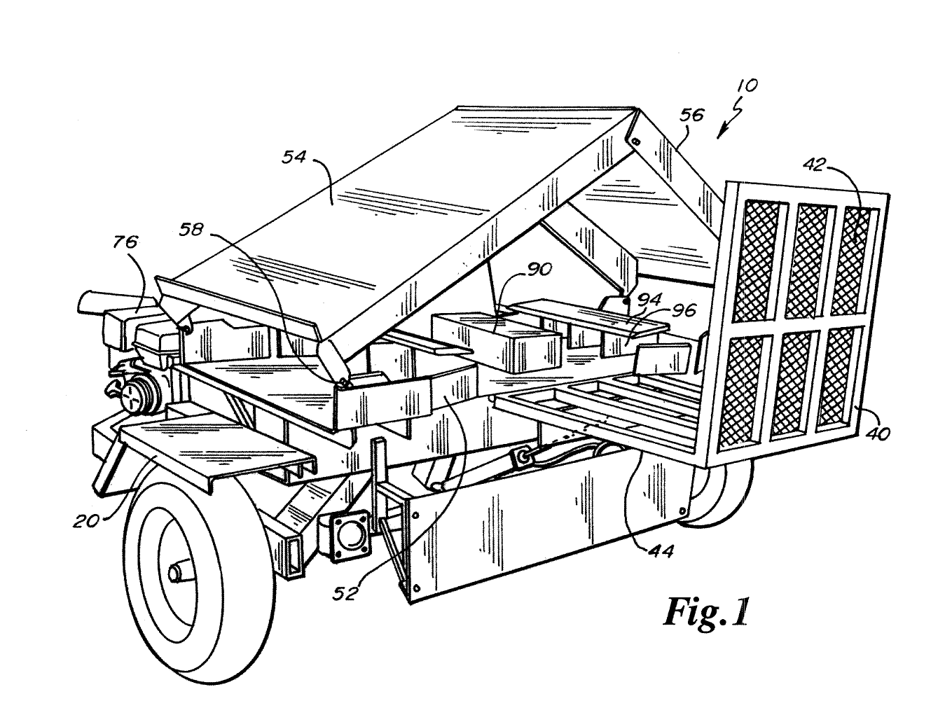

FIG. 1 illustrates the log splitter 10 mounted on a wheeled transportation vehicle 20 such as a trailer. In FIG. 1 the log splitter 10 is in the folded, transportable configuration. The L-shaped loading ramp 40 is in the raised position.

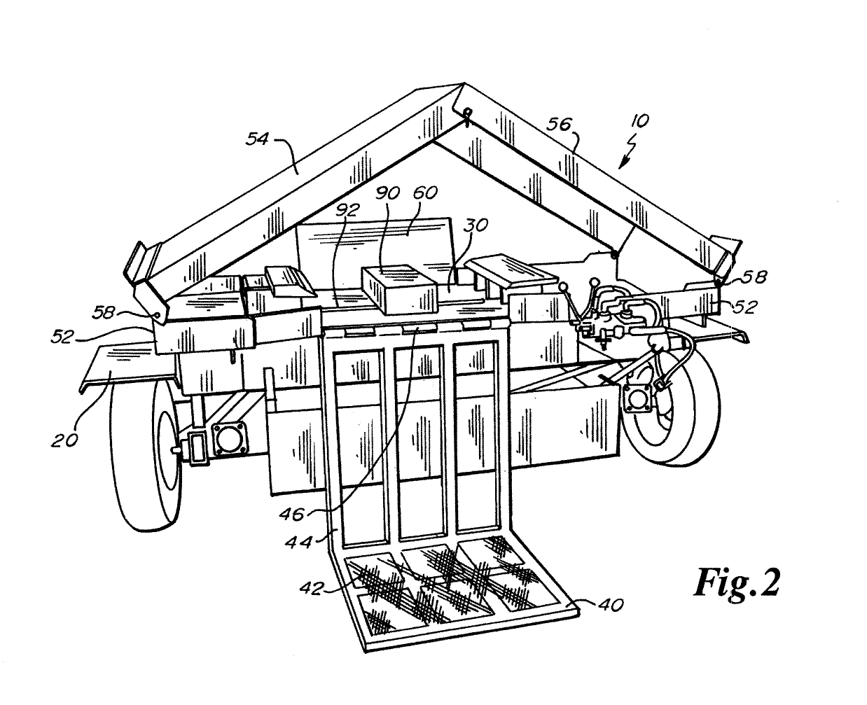

FIG. 2 illustrates the log splitter 10 as in FIG. 1, but with the loading ramp 40 in the lowered position after the device has been transported to the work site for loading logs onto the splitter 10.

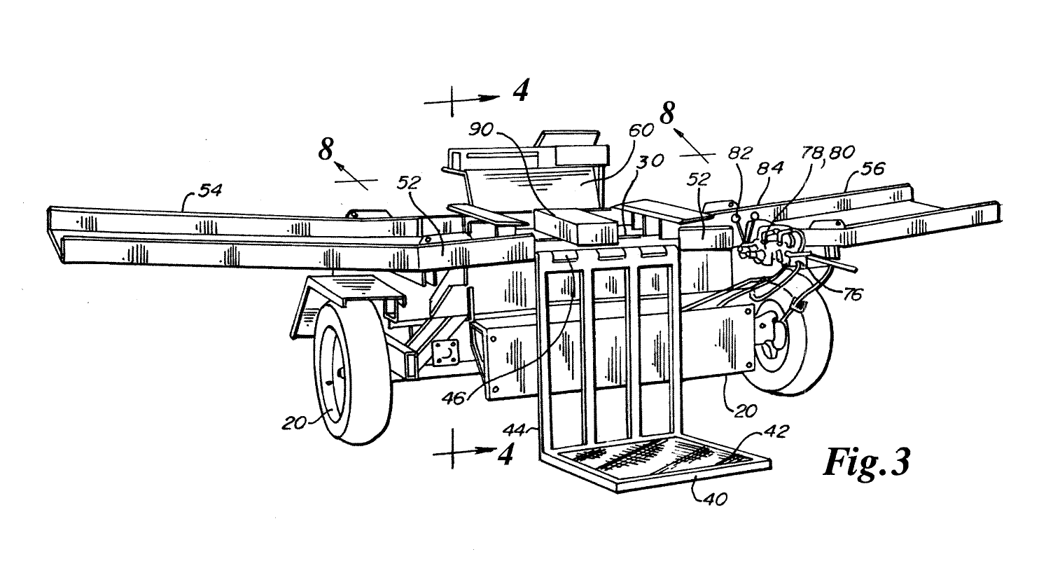

FIG. 3 illustrates the log splitter 10 in the unfolded, operational position ready to receive logs for splitting.

It will be seen from FIGS. 1-3 that the log splitter 10 has a primary splitting table 30 mounted on the wheeled transportation vehicle 20, loading ramp 40, secondary splitting tables 52, and log unloading tables or chutes 54, 56. On table 30 is located reciprocating log push block 90. Opposing primary and secondary splitting blades 94 and 96 are mounted on secondary splitting tables 52.

Loading ramp 40 is mounted to the wheeled transportation vehicle 20 suitably by hinges 46. Loading ramp 40 may preferably comprise mesh 42 and log support bars 44, as shown in FIGS. 1 and 2. Loading ramp 40 may be pivoted from the locked raised position shown in FIG. 1 to the lowered position shown in FIG. 2 by a hydraulic cylinder 46.

Log unloading tables 54, 56 are pivotally mounted suitably by pivot pins 58 on the secondary splitting tables 52. As shown in FIG. 3, to prepare the log splitter 10 for operation, the log unloading tables 54, 56 are pivoted from the locked position shown in FIG. 2 to the position shown in FIG. 3.

A backstop plate, guide, or guard 60 is mounted adjacent the primary splitting table 30 to keep the log L from falling off of table 30.

Turning now to FIG. 8, the structure of the primary splitting table 30 and associated driving mechanism may be appreciated. Primary splitting table 30 has a top plate 32, opposing side plates 33, bottom plate 34, and end plates 36. The top plate 32, bottom plate 34, and end plates 36 form a fixed channel box 37 with an enclosed space 38 therein.

A reversible hydraulic cylinder 70 is secured to one end plate 36 within the enclosed space 38. The reversible hydraulic cylinder 70 has a piston rod 72. The cylinder 70 is powered through hydraulic hoses from a hydraulic engine pump 76, which is mounted on the wheeled transportation vehicle 20 as shown in FIG. 1. Hydraulic control valves 78, 80 are activated respectively by operating levers 82, 84. Hydraulic control valve 78 and operating lever 82 activate the ramp 40 by hydraulic pressure. Hydraulic control valve 80 and operating lever 84 activate the reversible hydraulic cylinder 70. Bypass valves may also be used.

Returning again to FIG. 8, it will be seen that the piston rod 72 is connected by a linkage 86 to reciprocating box channel 88, within space 38 below splitting table 30, top plate 32 and slot 92 to reciprocally move log push block or plate 90. Box channel 88 suitably has log push block stem 87 passing therethrough and is welded in place. Upon stem 87 is welded log push block 90. Reciprocating stem 87, with log push block 90 thereabove, slides within a slot 92 (seen in FIG. 2 and 8-14) in the primary splitting table 30 with the push block 90 sliding back and forth on table 30.

More detail of the reciprocating box channel 88 may be appreciated in FIG. 14, where it will be seen that in the preferred embodiment the reciprocating box 88 is rectangular and hollow in cross-section. The hydraulic piston 70 and piston rod 72 lie protected within the hollow reciprocating box channel 88, which in turn lies within the operational space 38 within channel box 37 below the primary splitting table 30. By this arrangement, all movements of the push block 90, stem 87 and box channel 88 are supported for only linear movement left and right which maximizes hydraulic power for multiple simultaneous splits of log L.

The splitting mechanism may be appreciated in FIG. 1. Left and right mirror image primary splitting blades 94 are oriented substantially parallel to the secondary splitting tables 52. A plurality of secondary splitting blades 96 are mounted substantially vertically to the secondary splitting tables between the primary splitting blades 94 and the secondary splitting tables 52. Preferably, the secondary splitting table 52, primary splitting blades 94, and secondary splitting blades 96 are welded together for additional strength. Secondary splitting blades 96 are staggered behind primary blades 94 as to demand hydraulic power after the primary blades 94 have begun splitting log L and to minimize jams.

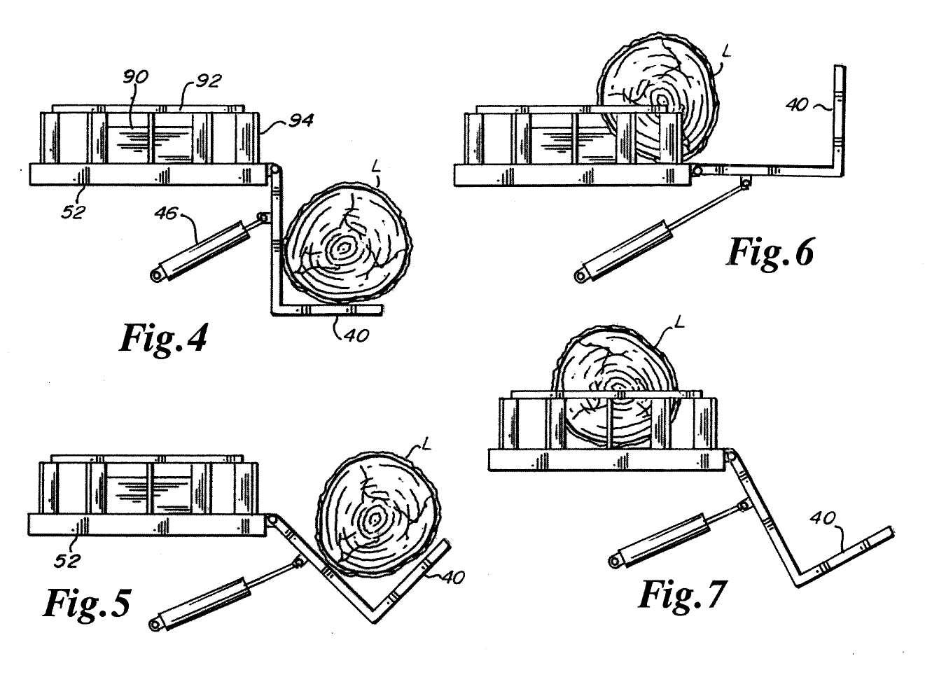

Operation of the log splitter 10 may now be described with reference to FIGS. 4-13.

With the log splitter 10 in the operating position, the operator rolls or places a log L on the ramp 40, as shown in FIG. 4. The operator then pulls the operating lever 82, activating hydraulic control valve 78 to provide hydraulic pressure to ramp hydraulic piston 46. This causes the ramp 40 to be raised successively to the positions shown in FIGS. 5 and 6, at which point the operator rolls the log L onto the primary splitting table 30 with backstop 60 holding the Log L on the primary splitting table 30. The operator then reverses the ramp hydraulic piston by pushing the operating lever 82, returning the ramp 40 to a lowered position, a step of which is shown in FIG. 7. The operator may then stand on the ramp 40 to control the log L splitting.

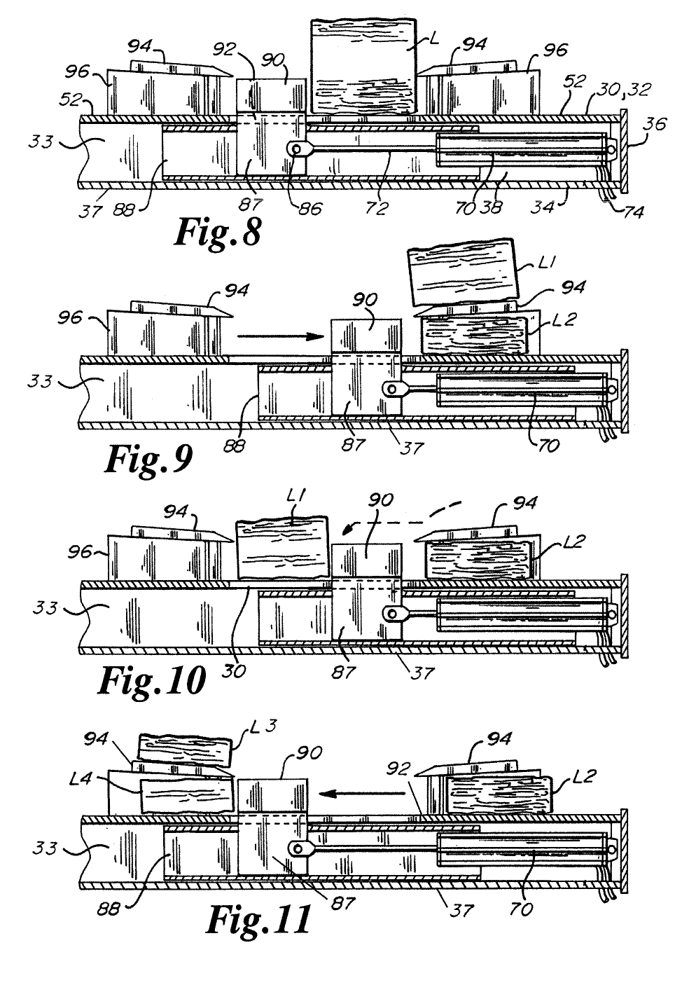

With the log L on the primary splitting table 30, the operator pulls operating lever 84, activating the reversible hydraulic piston 70, which in turn acts on the reciprocating box channel 88 and the log push block 90, forcing the log to the right (FIG. 9) against the primary splitting blade 94 and the secondary splitting blades 96. Simultaneously, the log

L is split into top portion L1 and bottom portion L2 by the primary splitting blade 94 and the bottom portion further split into split pieces L2 by the secondary splitting blades 96.

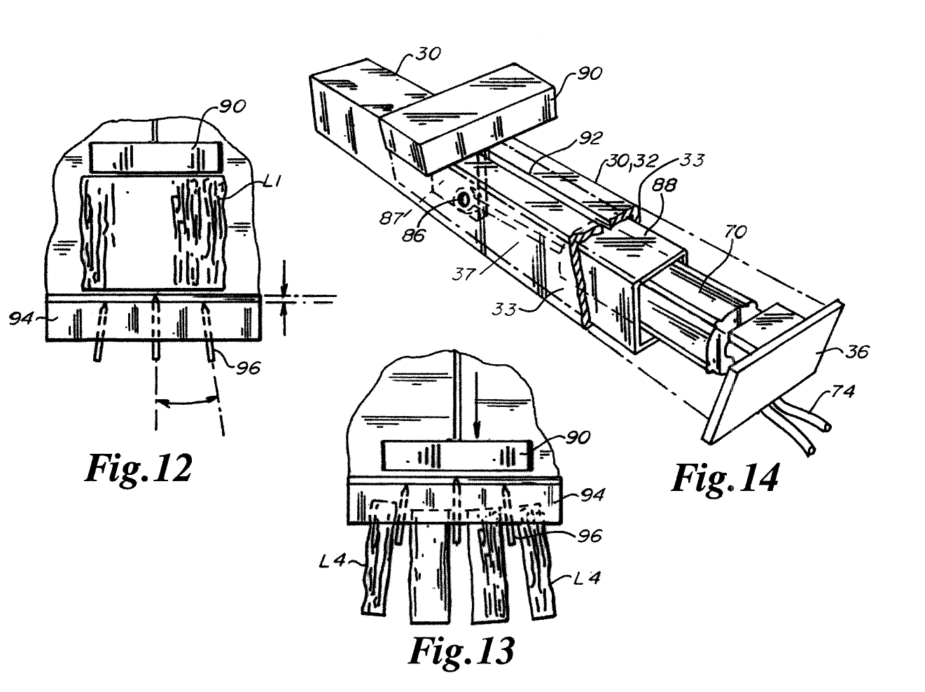

As shown in FIG. 10, the operator then slides (dashed arrow) the top portion L1 over log push block 90 to the primary splitting table 30 and then pushes the operating lever 84 to reverse the direction of motion of the reversible hydraulic piston 70. As shown in FIG. 11, this then causes the log push box or plate 90 to split the log portion L1 into L3 and split pieces L4 against the other opposite set of primary 94 and secondary 96 splitting blades as described above and seen in FIGS. 12 and 13. The vehicle 20 is simply backed up into the log pile as the pile diminishes. Two neat rows are formed for easy pickup of the split wood.

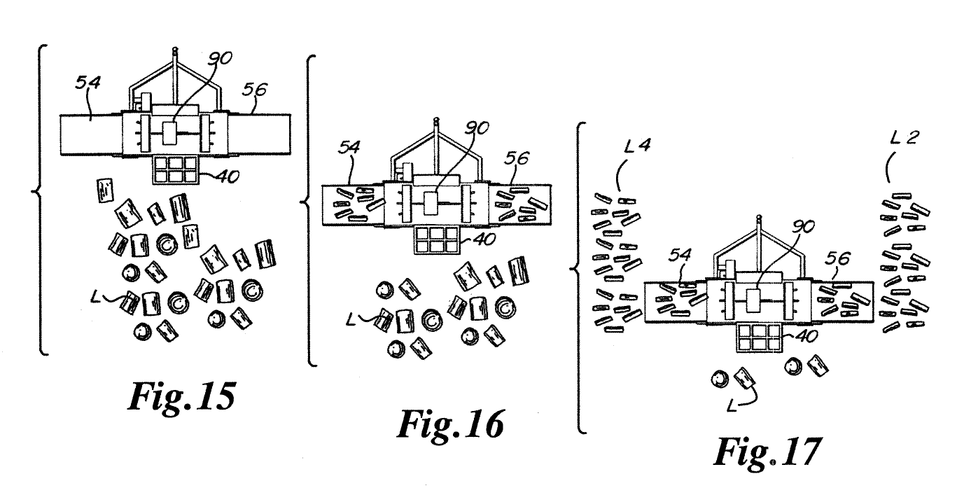

Operation continues, successively splitting logs against the splitting blades 94, 96 at opposite ends of the primary splitting table, with the split pieces being pushed off onto the log unloading tables 54, 56, as shown in FIGS. 15-17. Each log L may be loaded onto the primary splitting table 30 by using the ramp 40 as described above.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. A portable hydraulic log splitter comprising:
(a) a primary log splitting table mounted on a wheeled transportation vehicle with two lateral opposing secondary log splitting tables adjoining the primary splitting table;
(b) opposing horizontal primary splitting blades fixedly mounted above the secondary log splitting tables and opposing vertical secondary splitting blades fixedly mounted on the secondary log splitting tables, below and fixed to the primary splitting blades; and
(c) a lateral reciprocating hydraulically-driven log push block slideably mounted on the primary log splitting table wherein the log push block pushes the log simultaneously against one of the primary splitting blades and the adjoining secondary splitting blades, the primary splitting blade splitting the log into a first portion and a second portion, the secondary splitting blades simultaneously splitting the second portion into split pieces and wherein the log first portion is manually moved from on top of the primary splitting blade, over the log push block, onto the splitting table for opposite movement of the log push block pushing the log first portion simultaneously against the opposing primary splitting blade and the adjoining secondary splitting blades, the primary splitting blade splitting the log into a third portion and a fourth portion, the secondary splitting blade simultaneously splitting the fourth portion into more split pieces.

2. The log splitter of claim 1, wherein the secondary splitting blades are laterally outwardly staggered from the primary splitting blades.

3. The log splitter of claim 2, further comprising laterally opposing chutes that receive the split pieces to dispense the pieces outwardly into two opposing rows of split pieces away from the operator.

4. The log splitter of claim 1, further comprising a hydraulically activated L-shaped loading ramp adjacent the primary splitting table that lifts logs onto the primary splitting table from the ground and when lowered operates as an operator stand when operating the log splitter.

5. The log splitter of claim 4, further comprising a backstop mounted on the primary splitting table opposite the loading ramp to prevent the log from falling off the primary splitting table.

6. The log splitter of claim 1, further comprising a laterally extending slot in the primary splitting table wherein a stem mounted to the log push block extends therethrough the slot and below is connected to a hydraulic cylinder to move the log push block back and forth.

7. The log splitter of claim 1, further comprising laterally opposing chutes that receive the split pieces to dispense the pieces outwardly into two opposing rows of split pieces away from the operator and a hydraulically activated L-shaped loading ramp adjacent the primary splitting table that lifts logs onto the primary splitting table from the ground and when lowered operates as an operator stand when operating the log splitter, the chutes and ramp fold up into locked position for transportation of the log splitter.

8. A portable hydraulic log splitter comprising:
(a) a primary log splitting table mounted on a wheeled transportation vehicle with two lateral opposing secondary log splitting tables adjoining the primary splitting table;
(b) opposing horizontal primary splitting blades fixedly mounted above the secondary log splitting tables and opposing vertical secondary splitting blades fixedly mounted on the secondary log splitting tables, below and fixed to the primary splitting blades wherein the secondary splitting blades are laterally outwardly staggered from the primary splitting blades;
(c) a backstop mounted on the primary splitting table to prevent the log from falling off the primary splitting table; and
(d) a lateral reciprocating hydraulically-driven log push block slideably mounted on the primary log splitting table wherein the log push block pushes the log simultaneously against one of the primary splitting blades and the adjoining secondary splitting blades, the primary splitting blade splitting the log into a first portion and a second portion, the secondary splitting blades simultaneously splitting the second portion into split pieces and wherein the log first portion is manually moved from on top of the primary splitting blade, over the log push block, onto the splitting table for opposite movement of the log push block pushing the log first portion simultaneously against the opposing primary splitting blade and the adjoining secondary splitting blades, the primary splitting blade splitting the log into a third portion and a fourth portion, the secondary splitting blade simultaneously splitting the fourth portion into more split pieces.

9. The log splitter of claim 8, further comprising laterally opposing chutes that receive the split pieces to dispense the pieces outwardly into two opposing rows of split pieces away from the operator.

10. The log splitter of claim 8, further comprising a hydraulically activated L-shaped loading ramp adjacent the primary splitting table that lifts logs onto the primary splitting table from the ground and when lowered operates as an operator stand when operating the log splitter.

11. The log splitter of claim 8, further comprising a laterally extending slot in the primary splitting table wherein a stem mounted to the log push block extends therethrough the slot and below is connected to a hydraulic cylinder to move the log push block back and forth.

12. The log splitter of claim 8, further comprising laterally opposing chutes that receive the split pieces to dispense the pieces outwardly into two opposing rows of split pieces away from the operator and a hydraulically activated L-shaped loading ramp adjacent the primary splitting table that lifts logs onto the primary splitting table from the ground and when lowered operates as an operator stand when operating the log splitter, the chutes and ramp fold up into locked position for transportation of the log splitter.

13. A portable hydraulic log splitter comprising:
(a) a primary log splitting table mounted on a wheeled transportation vehicle with two lateral opposing secondary log splitting tables adjoining the primary splitting table;
(b) opposing horizontal primary splitting blades fixedly mounted above the secondary log splitting tables and opposing vertical secondary splitting blades fixedly mounted on the secondary log splitting tables, below and fixed to the primary splitting blades wherein the secondary splitting blades are laterally outwardly staggered from the primary splitting blades;
(c) a hydraulically activated L-shaped loading ramp adjacent the primary splitting table that lifts logs onto the primary splitting table from the ground and when lowered operates as an operator stand when operating the log splitter
(d) a backstop mounted on the primary splitting table opposite the loading ramp to prevent the log from falling off the primary splitting table;
(e) a lateral reciprocating hydraulically-driven log push block slideably mounted on the primary log splitting table and a laterally extending slot in the primary splitting table wherein a stem mounted to the log push block extends therethrough the slot and below is connected to a hydraulic cylinder to move the log push block back and forth; and
(f) laterally opposing chutes that receive the split pieces to dispense the pieces outwardly into two opposing rows of split pieces away from the operator, wherein the log push block pushes the log simultaneously against one of the primary splitting blades and the adjoining secondary splitting blades, the primary splitting blade splitting the log into a first portion and a second portion, the secondary splitting blades simultaneously splitting the second portion into split pieces and wherein the log first portion is manually moved from on top of the primary splitting blade, over the log push block, onto the splitting table for opposite movement of the log push block pushing the log first portion simultaneously against the opposing primary splitting blade and the adjoining secondary splitting blades, the primary splitting blade splitting the log into a third portion and a fourth portion, the secondary splitting blade simultaneously splitting the fourth portion into more split pieces.
